(19) United States
(12) Patent Application Publication
(10) Pub. No.: US 2009/0080010 A1
(43) Pub. Date: Mar. 26, 2009

(54) IMAGE FORMING APPARATUS, IMAGE FORMING METHOD, AND PROGRAM

(75) Inventor: Yoshihito Nanaumi, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/211,519

(22) Filed: Sep. 16, 2008

(30) Foreign Application Priority Data
Sep. 21, 2007 (JP) 2007-246092
Aug. 21, 2008 (JP) 2008-213227

(51) Int. Cl. G06F 3/12

(52) U.S. Cl. 358/1.13; 358/1.15

(57) ABSTRACT

An image forming apparatus of this invention causes a user to select a function to be executed by the image forming apparatus and determines the priority order of a document based on the selected function, the storage location of the document, and the attribute information of the document. A document is searched for based on the selected function. The list of documents selected from documents found by a search unit is displayed based on the determined priority order. If the search unit has found documents having the same contents, a document having a highest priority order is displayed in the list.

### BACKGROUND OF THE INVENTION

1. Field of the Invention

The present invention relates to an image forming apparatus which incorporates a document storage unit and searches for a desired document.

2. Description of the Related Art

Recent image forming apparatuses are becoming more multifunctional, and various techniques have been developed to improve the efficiency of user operations of a variety of functions.

One of the variety of functions of an image forming apparatus is reuse of a file or the like. Japanese Patent Laid-Open No. 2006-302038 describes a job management apparatus which saves customer information and jobs in a file server and quickly copes with a reprint request from a user. As one of user functions, a box function is widely known which saves data received via a scanner or the like in a file format. In the box function, a file system for saving a file in a device such as an image forming apparatus is called a “box”. A user can extract a desired file from the box and reuse it. For example, an image file saved in the box of an image forming apparatus can easily be reprinted or retransmitted to an external device.

Conventionally, a box function is often operated in a system where an image forming apparatus whose functions are operated by a user is identical to an image forming apparatus including a box. Such a box will particularly be referred to as a local box. Unlike the local box, if an image forming apparatus to which user operations are input is different from an image forming apparatus including a box on a network, the box will particularly be referred to as a remote box. Recently, the box function is often executed not only for a local box but also for a remote box.

An example of the application purpose of file reuse by a user is a print function. Conventionally, when a user gives the instruction for printing of a file stored in a box, he/she can designate only data suitable for printing (bitmap data for printing or data obtained by compressing such data). Data suitable for printing is data that has undergone RIP processing or image processing for printing. This data will be referred to as print ready data. Generally, print ready data is bitmap data rasterized immediately before printing and therefore has large data amount. Although this data has undergone RIP processing or print output processing of each model and is therefore highly model-dependent, the data can be printed at high speed. The box can store not only print ready data but also data having a format suitable for sending. The data suitable for sending (data easy to use in another device) will be referred to as connect ready data. For example, PDF is suitable for use in another device such as a PC and has a file format usable as connect ready data. Connect ready data is data before RIP processing. For this reason, the connect ready data requires a longer time until printing than print ready data. However, since the connect ready data is data before model-dependent processing, the model dependence is low, and the versatility is high.

In the conventional box operation, it is unnecessary to consider the difference in the data format or the difference between the local box and the remote box. In recent years, however, the file storage location and data format have diversified, as described above, and the need for selecting an appropriate file corresponding to a user operation is growing.

Documents having the same contents are sometimes stored using different file formats. If these documents are displayed as a list regardless of their storage locations and data formats, the user cannot distinguish the documents. Consequently, for example, a document not in the local box but in the remote box may be processed. Processing that should be executed for print ready data may be executed for connect ready data. In this case, print processing may require an extra time because the documents which appear to be identical for the user have different process paths depending on the document storage location or data format.

If both the local box and the remote box are used as document storage locations, or both connect ready data and print ready data are used as document formats, as described above, it is preferable to encourage the user to select an appropriate document. In fact, however, selection by the user is difficult and decreases the convenience.

### SUMMARY OF THE INVENTION

The present invention provides an image forming apparatus which allows a user to unconsciously perform an operation for an optimum document.

The present invention in its first aspect provides an image forming apparatus comprising:

a function selection unit configured to cause a user to select a function to be executed by the image forming apparatus;

a determination unit configured to determine a priority order of a document based on the selected function, a storage location of the document, and attribute information of the document;

a search unit configured to search for a document based on the selected function; and

a display unit configured to display a list of documents selected from documents found by the search unit based on the priority order determined by the determination unit,

wherein when the search unit has found documents having the same contents, the display unit displays a document having a highest priority order in the list.

The present invention in its second aspect provides an image forming method comprising:

a function selection step of causing a user to select a function to be executed by an image forming apparatus;

a determination step of determining a priority order of a document based on the selected function, a storage location of the document, and attribute information of the document;

a search step of searching for a document based on the selected function; and

a display step of displaying a list of documents selected from a plurality of documents found in the search step based on the priority order determined in the determination step,

wherein when documents having the same contents have been found in the search step, a document having a highest priority order is displayed in the list in the display step.

The present invention in its third aspect provides a computer program stored in a computer-readable storage medium, the program causing an image forming apparatus to execute:

a function selection step of causing a user to select a function to be executed by the image forming apparatus;

a determination step of determining a priority order of a document based on the selected function, a storage location of the document, and attribute information of the document;

a search step of searching for a document based on the selected function; and

a display step of displaying a list of documents selected from a plurality of documents found in the search step based on the priority order determined in the determination step,

wherein when documents having the same contents have been found in the search step, a document having a highest priority order is displayed in the list in the display step.

According to the present invention, if documents having the same contents are found by a document search, only a document having a highest priority order is displayed, thereby preventing a plurality of documents having the same contents from being displayed and also displaying a document that can be output fastest. Since the user unconsciously performs an operation for an optimum document, the convenience can be increased.

Further features of the present invention will become apparent from the following description of exemplary embodiments with reference to the attached drawings.

### BRIEF DESCRIPTION OF THE DRAWINGS

FIG. 1 is a view showing an example of the arrangement of an image forming system according to the embodiment of the present invention;

FIG. 2 is a block diagram showing the arrangement of the functional blocks of an image forming apparatus shown in FIG. 1;

FIGS. 3A and 3B are tables showing paths corresponding to the functions of the image forming apparatus;

FIG. 4 is a view showing the data area of a data management unit shown in FIG. 2;

FIG. 5 is a view showing a data mapping table referred to when determining a document priority order;

FIG. 6 is a view showing an example of the layout of an operation unit shown in FIG. 2;

FIG. 7 is a view showing an example of the window of a touch panel unit shown in FIG. 6;

FIG. 8 is a view showing an example of the window displayed for print processing;

FIG. 9 is a view showing an example of the window that displays search results;

FIG. 10 is a view showing an example of the window that displays the detailed information of a document;

FIGS. 11A and 11B are flowcharts illustrating a procedure of data processing according to the embodiment of the present invention; and

FIGS. 12A and 12B are flowcharts illustrating another procedure of data processing according to the embodiment of the present invention.

### DESCRIPTION OF THE EMBODIMENTS

The best mode for carrying out the present invention will now be described in detail with reference to the accompanying drawings. The same reference numerals denote the same constituent elements, and a description thereof will be omitted.

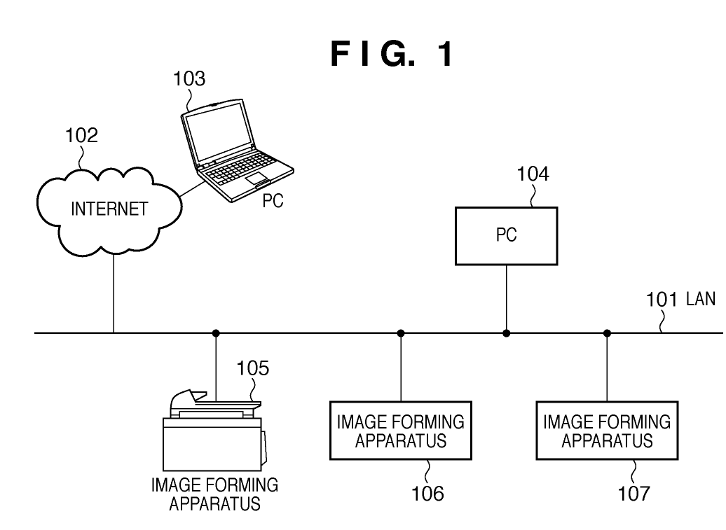

FIG. 1 is a view showing an example of the arrangement of an image forming system according to the embodiment of the present invention. As shown in FIG. 1, the image forming system includes a LAN 101, print client apparatuses 103 and 104, and image forming apparatuses 105, 106, and 107. In this embodiment, each of the image forming apparatuses 106 and 107 is an MFP (Multi Function Peripheral). The image forming apparatus 105 is an SFP (Single Function Peripheral). Each of the print client apparatuses 103 and 104 may use, for example, a PC. The devices connected to the LAN 101 can communicate with each other using a predetermined protocol. The print client apparatus 103 is connected to the LAN 101 via the Internet 102. The print client apparatuses 103 and 104 may load system resources such as a printer driver from a hard disk (not shown) or the like to a RAM. Each print client apparatus may be designed to display the print control window of a printer driver and respond to a print request from a user upon receiving a print request from an application.

The image forming apparatus 107 shown in FIG. 1 incorporates a memory such as a hard disk capable of storing a plurality of job data. The image forming apparatus 107 has a plurality of functions including a copy function of causing its printer unit to print, via the memory, job data (a scan job including a scan image) output from a scanner. The image forming apparatus also has a print function of causing its print unit to print, via the memory, job data (a print job including print data) output from the print client apparatus 103 or 104 that is an external device.

In this embodiment, not only a multifunctional image forming apparatus having a plurality of functions, such as the image forming apparatus 106 or 107 shown in FIG. 1, but also a single-function image forming apparatus such as the image forming apparatus 105 having, for example, only a print function may be connected to the LAN 101. A plurality of multifunctional image forming apparatuses may be connected to the LAN 101. A plurality of single-function image forming apparatuses may be connected to the LAN 101.

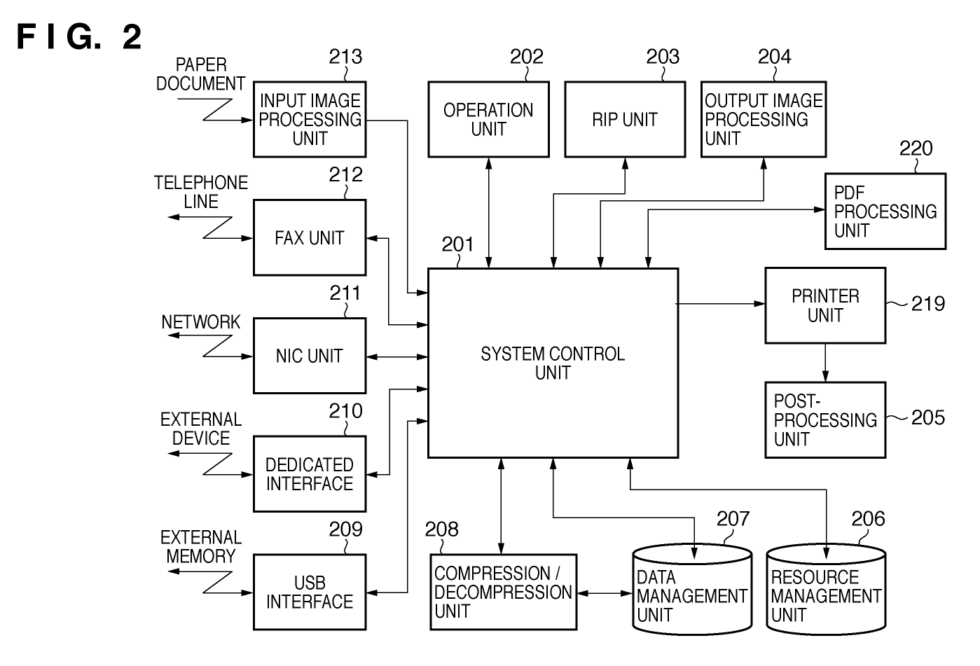

FIG. 2 is a block diagram showing the arrangement of the functional blocks of an image forming apparatus shown in FIG. 1. FIG. 2 will be described below as the internal arrangement of the image forming apparatus 107 serving as an MFP. This also applies to the image forming apparatus 106. As shown in FIG. 2, the image forming apparatus includes an input image processing unit 213, FAX unit 212, NIC (Network Interface Card) unit 211, dedicated interface unit 210, and USB (Universal Serial Bus) interface unit 209. The input image processing unit 213 reads the image of, for example, a paper document and processes the read image data. The FAX unit 212 transmits/receives an image using a telephone line represented by a facsimile or the like. The NIC unit 211 transmits/receives various kinds of data such as image data, document data, and device information using a network. The dedicated interface unit 210 exchanges information with an external device. The USB interface transmits/receives data to/from a USB device represented by a USB memory that is a kind of removable medium.

A system control unit 201 shown in FIG. 2 temporarily stores data in accordance with the application purpose or determines a route (will also be referred to as a path hereinafter) between the functional blocks, thereby controlling the entire system. A data management unit 207 includes a memory such as a hard disk capable of storing various kinds of data such as a plurality of image data or document data. For example, the CPU of the system control unit 201 mainly controls to store a plurality of various kinds of data in the hard disk. Image data from the input image processing unit 213 or image data of a facsimile job input via the FAX unit 212 may be used as the data. Image data or document data input, via the NIC unit 211, from an external device such as a computer or data input via the dedicated interface unit 210 or USB interface unit 209 may also be used.

The CPU of the system control unit 201 can mainly control to read out and process data stored in the hard disk as needed, transfer the data to a printer unit 219 or an output image processing unit 204, and execute output processing such as printer processing. It is also possible to control to transfer various kinds of data read out from the hard disk to an external device such as a computer or another image forming apparatus in accordance with a user instruction.

Various kinds of data are sometimes compressed, as needed, and then stored in the data management unit 207. Additionally, data that has been compressed and stored is often read out and then decompressed. A compression/decompression unit 208 can execute this processing. Generally, data to be sent via a network is compressed by a method such as JPEG, JBIG, or ZIP in some cases. For example, when the image forming apparatus sends or receives data via a network, the compression/decompression unit 208 can compress or decompress the data.

A resource management unit 206 stores various parameter tables to be commonly handled, including fonts, color profiles, and a gamma table. The parameter tables can be invoked, corrected, and updated as needed. It is also possible to create a new parameter table and store it in the resource management unit 206.

A RIP unit 203 executes RIP (Raster Image Processor) processing upon receiving PDL data. The output image processing unit 204 executes image processing of an image to be printed as needed. Data (i.e., print ready data) that has undergone RIP processing (and image processing) can be stored in the data management unit 207 as needed. Print ready data indicates bitmap data or compressed bitmap data for printing. Print ready data is sent to the printer unit 219 so that image formation processing (i.e., print processing) is performed. Sheets printed by the printer unit 219 are fed to a post-processing unit 205 and subjected to sheet sorting processing or sheet finishing processing.

A PDF processing unit 220 interprets connect ready data stored in the data management unit 207 or connect ready data such as PDF data input via the NIC unit 211.

The PDF processing unit 220, RIP unit 203, output image processing unit 204, and system control unit 201 can cooperate and exchange connect ready data and print ready data.

The characteristic features of print ready data and connect ready data will be described here. Print ready data is generated after RIP processing by the RIP unit 203 or image processing by the output image processing unit 204 for printing. The print ready data that is processed for printing will also be referred to as processed data hereinafter. Print ready data is bitmap data rasterized immediately before printing and therefore has a large data amount. Print ready data is highly model-dependent because RIP processing or image processing for printing is executed in correspondence with each apparatus model. However, the print ready data can be printed at a high speed. On the other hand, connect ready data is data before RIP processing. For this reason, the speed of print processing of connect ready data is lower than that of print ready data. However, the model dependence is low (the versatility is high) because it is data before RIP processing or print output processing. The connect ready data that is not yet processed for printing will also be referred to as preprocess data hereinafter.

The system control unit 201 of the image forming apparatus sets an appropriate path between the functional blocks shown in FIG. 2 in accordance with jobs of various functions designated by the user.

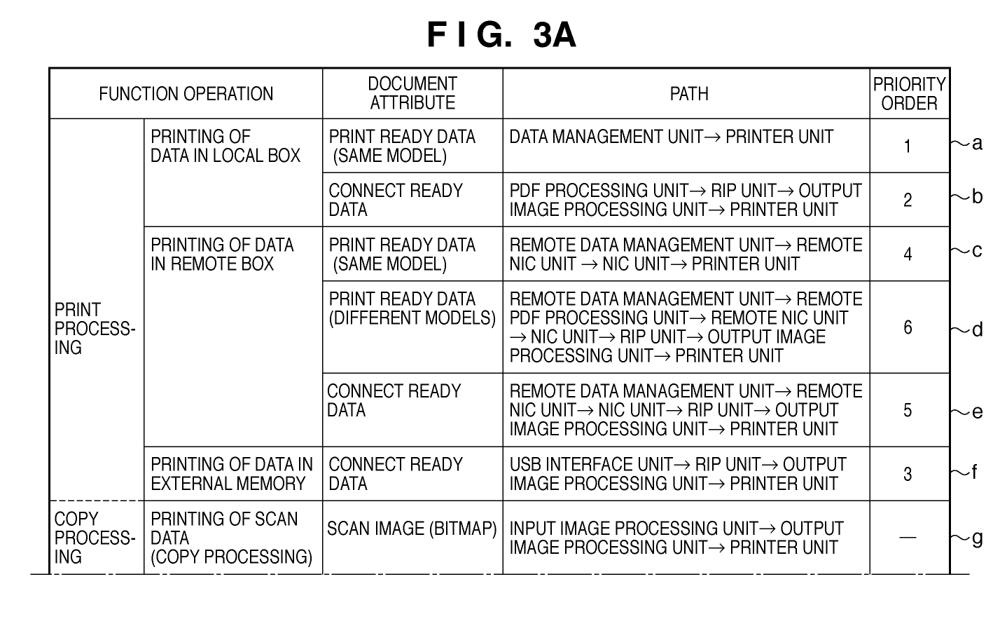

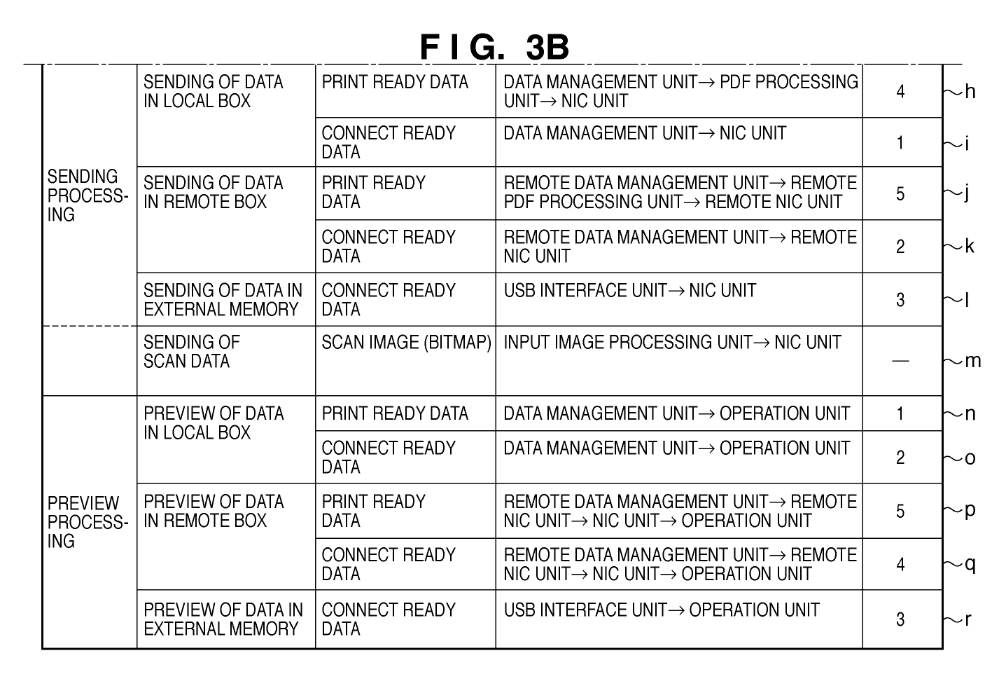

FIGS. 3A and 3B show the correspondence between the contents of user operations (functions designated by the user), the types (document attributes) of process target data, and the paths of the functional blocks to process the data. FIGS. 3A and 3B show the outline of process paths. Processes of the compression/decompression unit 208, post-processing unit 205, PDF processing unit 220, system control unit 201, and the like which are used as needed are not illustrated. Except the paths shown in FIGS. 3A and 3B, image data may be stored as intermediate data in part of the process paths, as needed.

In addition to the functions shown in FIGS. 3A and 3B, combinations with various functions such as an e-mail service or Web server function are sometimes implemented. A process function of the image forming apparatus for data write and readout using the data management unit 207 may be implemented. A user ID and a password may be associated with a box for storing data, and user authentication may be done for use of the box.

The operation unit 202 shown in FIG. 2 is operated by the user and executes selection of various functions shown in FIGS. 3A and 3B or display of a document. For example, it is possible to cause the display device of the operation unit 202 to display a preview of image data stored in the data management unit 207 and then print the data after confirmation by the user. The operation unit 202 will be described later in detail.

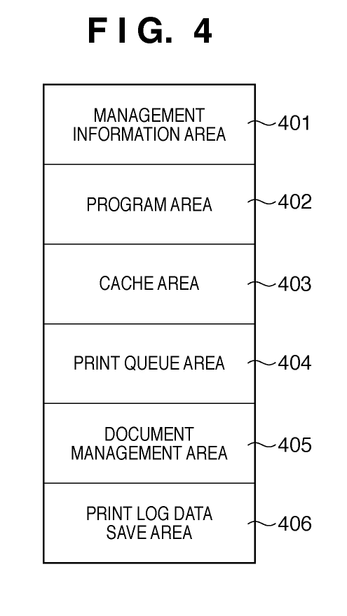

FIG. 4 is a view showing the data area of the data management unit. As shown in FIG. 4, the data area of the data management unit 207 includes areas 401, 402, 403, 404, 405, and 406. The area 401 is used as a management information area to store management information of the data management unit 207. The area 402 is used as a program area to store computer programs for controlling the image forming apparatus 107. The programs are used to cause the image forming apparatus to execute the processes of flowcharts to be described later. The area 403 is used as a cache area to temporarily save data during processing of the system control unit 201. The area 404 is used as a print queue area, that is, a spool area of data before printing. The area 405 is used as a document management area in a document management function. The area 406 is used as a print log data save area to save a print log.

The functions of the image forming apparatus according to this embodiment will be described next. A document management function is a function of saving document data or image data which can undergo various kinds of processing. This function will also be referred to as a box function hereinafter. The data management is performed in the area 405 of the data management unit 207. In this function, the area 405 serving as the document management area is divisionally used as a data management area and a document management information area. The print ready data and connect ready data already described are stored and managed in the data management area.

A search function is a function of searching for desired document data or image data stored in the data management unit 207. For a search, the user can designate search conditions.

An external search function is a function of searching for desired document data or image data in an external device. Using the external search function, the image forming apparatus can transmit a search processing instruction to an external device via the NIC unit 211 and request to search for desired data in the external device. The image forming apparatus can also receive the search result via the NIC unit 211.

Process paths corresponding to data storage locations or data formats in each processing will be explained next.

FIGS. 3A and 3B described above may be used as a table to be referred to in determining a document priority order. As shown in FIGS. 3A and 3B, a priority order representing a document attribute of a document to be preferentially processed is associated with each function operation (each function designated by the user). A document attribute includes information such as a data type (print ready data or connect ready data) and document storage location (local box or remote box). As can be seen from FIGS. 3A and 3B, for example, if an instruction to print document data stored in the local box is issued, and the document data is stored as both print ready data and connect ready data, print ready data with a smaller priority order number is preferentially processed.

If an instruction to print data stored in the remote box is given, it is determined whether the local apparatus and the remote apparatus are of the same model. The local apparatus is an image forming apparatus having a local box. The remote apparatus is an image forming apparatus having a remote box. The remote apparatus will also be referred to as a remote image forming apparatus hereinafter. The image forming apparatus may acquire model information from the remote apparatus and determine the model identity using, for example, SNMP (Simple Network Management Protocol) that is widely known as a network device management protocol. If document data is stored in the remote box as both print ready data and connect ready data, and it is determined that the model of the local apparatus and that of the remote apparatus are identical, print ready data with a smaller priority order number is preferentially processed. On the other hand, if the model of the local apparatus and that of the remote apparatus are different, connect ready data is preferentially processed. When it is determined that the apparatuses are of the same model, the job is processed through the path of the remote data management unit in the remote apparatus→remote NIC unit in the remote apparatus→NIC unit 211→printer unit 219, as shown in FIGS. 3A and 3B. That is, print ready data is pulled from the remote apparatus and printed by the image forming apparatus. When it is determined that the apparatuses are of different models, the job is processed through the path of the remote data management unit in the remote apparatus→remote PDF processing unit→remote NIC unit→NIC unit 211→RIP unit 203→output image processing unit 204→printer unit 219, as shown in FIGS. 3A and 3B. That is, connect ready data is pulled from the remote apparatus, converted into print ready data by the RIP unit 203 of the image forming apparatus, and printed.

Note that the priority order is assigned sequentially from data that requires a shorter print processing time in consideration of the conversion time between connect ready data and print ready data, the image processing time of the output image processing unit 204, and the communication time between the remote apparatus and the local apparatus via the NIC unit 211. The print processing time is a time from input of a function operation by the user to execution of a function corresponding to the function operation.

When an instruction to send data stored in the local box is given, the priority order is determined depending on the storage location of the target data. As shown in FIGS. 3A and 3B, if the data stored in the local box is print ready data, the job is processed through the path of the data management unit 207→PDF processing unit 220→NIC unit 211. If the data stored in the local box is connect ready data, the job is processed through the path of the data management unit 207→NIC unit 211.

To send data stored in the remote box, the job is processed through a path (route) shown in FIGS. 3A and 3B. If the data stored in the remote box is print ready data, the job is processed through the path of the remote data management unit in the remote apparatus→PDF processing unit 220→remote NIC unit. If the data stored in the remote box is connect ready data, the job is processed through the path of the remote data management unit in the remote apparatus→remote NIC unit.

Hence, the priority order for sending processing is assigned sequentially from data that requires a shorter processing time in each process path, as shown in FIGS. 3A and 3B.

When the image processing apparatus is to preview data stored in the local box, and the data is print ready data, the job is processed through the path of the data management unit 207→operation unit 202, as shown in FIGS. 3A and 3B. For connect ready data as well, the job is processed through the path of the data management unit 207→operation unit 202.

When the image processing apparatus is to preview data stored in the remote box, the job is processed through the path of the remote data management unit in the remote apparatus→remote NIC unit→NIC unit 211→operation unit 202, as shown in FIGS. 3A and 3B.

Hence, the priority order for preview processing is assigned sequentially from data that requires a shorter processing time in each process path, as shown in FIGS. 3A and 3B.

In this embodiment, the table shown in FIGS. 3A and 3B may be stored in a memory (not shown) such as a RAM in the image forming apparatus.

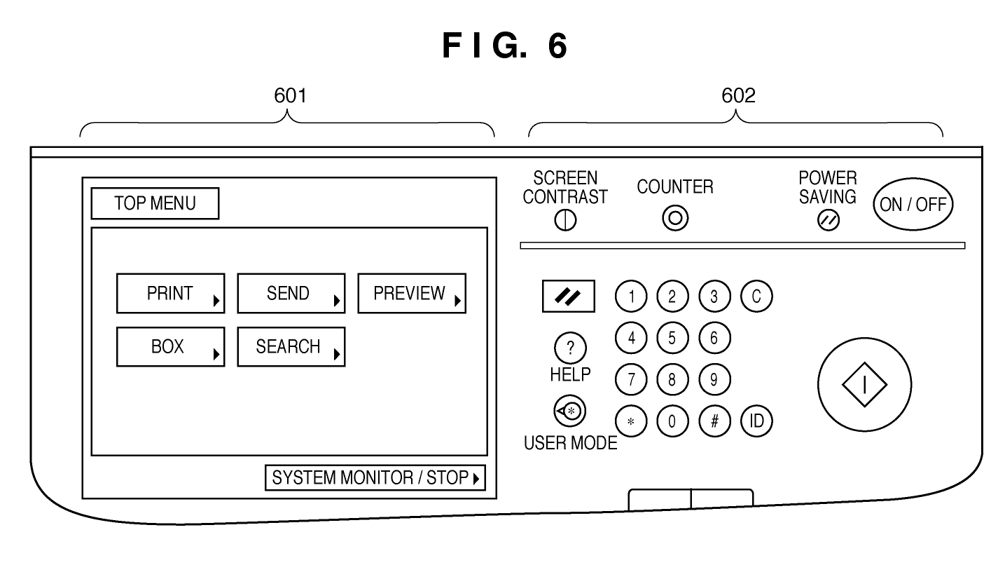

The operation unit 202 of the image forming apparatus according to the embodiment will be described next. FIG. 6 is a view showing an example of the layout of the operation unit 202 according to the embodiment. As shown in FIG. 6, the operation unit 202 includes a touch panel unit 601 and a key input unit 602. The key input unit 602 capable of steady operation settings includes a start key, stop key, ten-key pad, clear key, reset key, and user mode key.

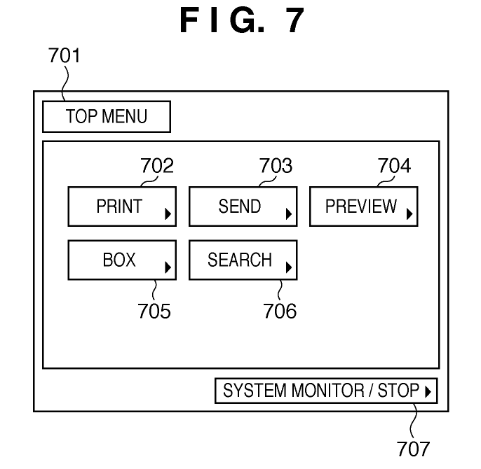

FIG. 7 is a view showing an example of the layout of the touch panel unit shown in FIG. 6. FIG. 7 is a schematic view of a touch panel display including an LCD (Liquid Crystal Display) and a transparent electrode bonded on it. The touch panel is programmed in advance to display, for example, another operation window upon detecting that the user has touched, with a finger, the transparent electrode at a portion corresponding to a key displayed on the LCD. FIG. 7 shows the initial window (top menu) in the standby mode. Various operation windows can be displayed in accordance with setting operations.

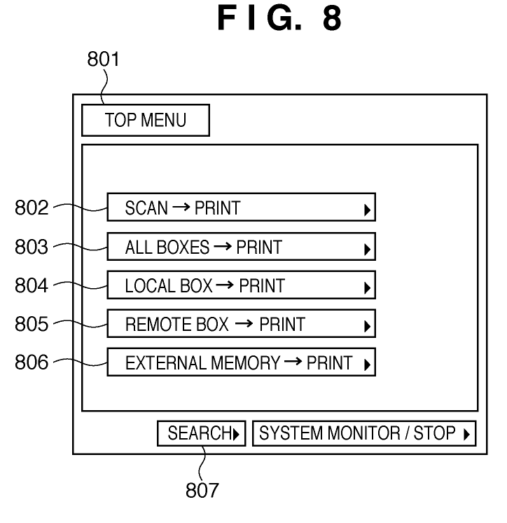

A tab 701 is used to return to the initial window. When the user selects the tab, the window returns to the initial window before various settings are done. Even in another window, when the user selects the top menu tab displayed on it, the window returns to the initial window. A tab 702 is used to shift to a window for printing. When the user selects the tab 702, the window transits to a print sub menu window shown in FIG. 8. A tab 703 is used to shift to a data sending sub menu window. When the user selects the tab 703, the window transits to a window for causing the user to select sending from box data or sending from document scan. When the user selects a tab 704, the window changes to a window for causing the user to select preview of a document stored in the local box, preview of a document stored in the remote box, or preview of a document in an external memory. When the user selects a tab 705, the window changes to a window for causing the user to designate a desired box and displaying the list of documents stored in the box designated by the user. After that, desired processing can be executed for a document selected by the user. A tab 706 is used to change to a window for document search. When the user selects the tab 706, the window changes to a window for searching for given document data stored in an external memory, external device, remote box, or local box. A tab 707 is used to change to a window for system settings. In this embodiment, for example, a tab for selecting a window for FAX function settings may be arranged in addition to the tabs shown in FIG. 7.

FIG. 8 is a view showing an example of the window displayed for print processing. The window shown in FIG. 8 can be displayed by pressing the tab 702 in the initial window shown in FIG. 7. A tab 801 in FIG. 8 is used to change to the initial window shown in FIG. 7. A tab 802 is used to change to a window for detailed settings and execution of processing of causing a scanner to scan a document and causing the printer unit to print it. Tabs 803, 804, and 805 are used to change to a window for printing data stored in a storage device. When the user designates the tab 803, the process target includes documents stored in all storage devices, that is, the local box, remote box, and external memory. When the user designates the tab 804, the process target includes documents stored in the local box. When the user designates the tab 805, the process target includes documents stored in the remote box. When the user designates a tab 806, the process target includes documents stored in the external memory. A tab 807 is used to change to a window for presetting document data search conditions. When the user selects the tab 807, a dialogue is displayed to confirm whether the user wants to do detailed settings for search (search conditions) or detect all target documents. The user may be able to set ON/OFF of display of the dialogue by system settings. For example, all found target documents may be displayed when system settings are done not to display the dialogue.

FIG. 8 shows a sub menu window displayed for print processing. When the user selects, for example, the tab 703 or 704 in FIG. 7, a sub menu window for detailed settings of corresponding processing can be displayed. In this case as well, a tab serving as a search user interface is arranged in correspondence with the function, like the tab 807. That is, the user can do settings for document search in advance in the sub menu window displayed by selecting one of the tabs 702 to 704 in FIG. 7.

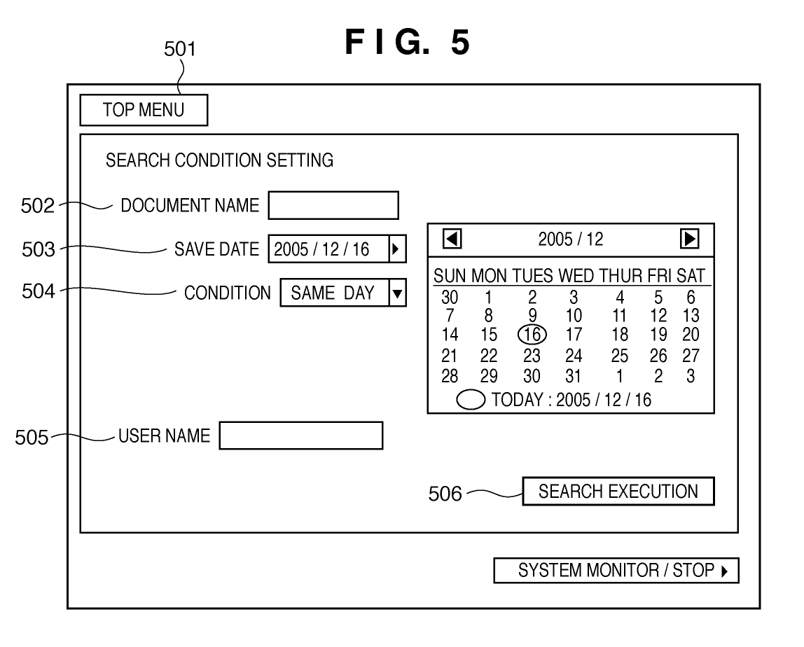

When the user selects one of the tabs 803 to 806 in FIG. 8, the window changes to a search condition setting window as shown in FIG. 5 for search in a corresponding storage device. When the user selects a tab 501 in FIG. 5, the window returns to the initial window. Referring to FIG. 5, the user can set, as search conditions, a document name (display 502), a save date (display 503), a condition (display 504) for setting the save date range, and a name (display 505) of a user who has saved documents. It is possible to set, by the range condition (display 504), for example, the “same day” as the date designated by display 503, days in a range before the date designated by display 503, or days in a range after the designated date. When the user sets search conditions and selects a search execution tab 506, a search is performed in the storage device designated by one of the tabs 803 to 806 in FIG. 8. In this embodiment, the user can set a document name, save date, and user name as the search conditions. However, the present invention is not limited to this. A search may be done based on any other information added to a document. When the user has selected the tab 807 and done search condition settings in advance, a search may be executed while skipping the search condition setting step upon selecting one of the tabs 803 to 806 in FIG. 8.

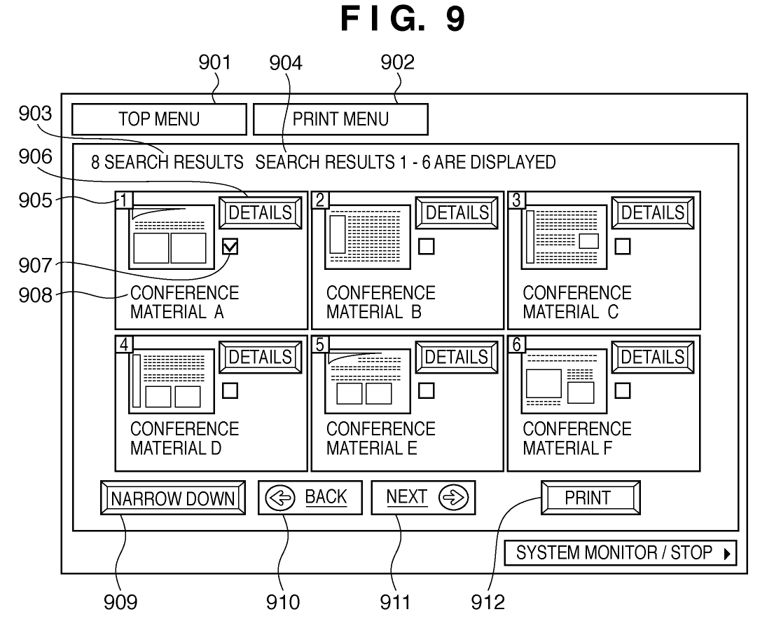

FIG. 9 is a view showing an example of the window that displays search results. The window shown in FIG. 9 is displayed by, for example, selecting the tab 506 for search execution in the window shown in FIG. 5. A tab 901 in FIG. 9 is used to return to the initial window shown in FIG. 7. A tab 902 is used to change to the print sub menu window shown in FIG. 8. A display 903 indicates the number of search results and, for example, indicates that there are eight search results. A display 904 indicates the number of search results displayed in the window and, for example, indicates that results 1 to 6 of the total of eight search results are displayed. A display 905 indicates the order of a search result. For example, the display 905 indicates that the order of the search result is “1”. The search order may be determined in consideration of the priority order table shown in FIGS. 3A and 3B. A tab 906 is used to change to a window for displaying detailed information of the document. A check box 907 indicates whether the document is selected by the user. When the check box is ON, it indicates that the document is selected. When the check box is OFF, it indicates that the document is not selected. A display 908 indicates a document name such as “conference material A”. A tab 909 is used to change to a window for narrowing down the search conditions. To narrow down, the user sets additional search conditions in the search condition setting window as shown in FIG. 5. Tabs 910 and 911 are used to move the search result display back and forth. A tab 912 is used to print the document whose check box 907 is ON. The tabs 902 and 912 are displayed when the user selects the tab 806 in the print window shown in FIG. 8. They are not displayed when the search result display window shown in FIG. 9 is displayed by pressing the tab 706 in the initial window shown in FIG. 7. The display 905 may simply indicate the order of the display 908 indicating the document name, instead of indicating the priority order.

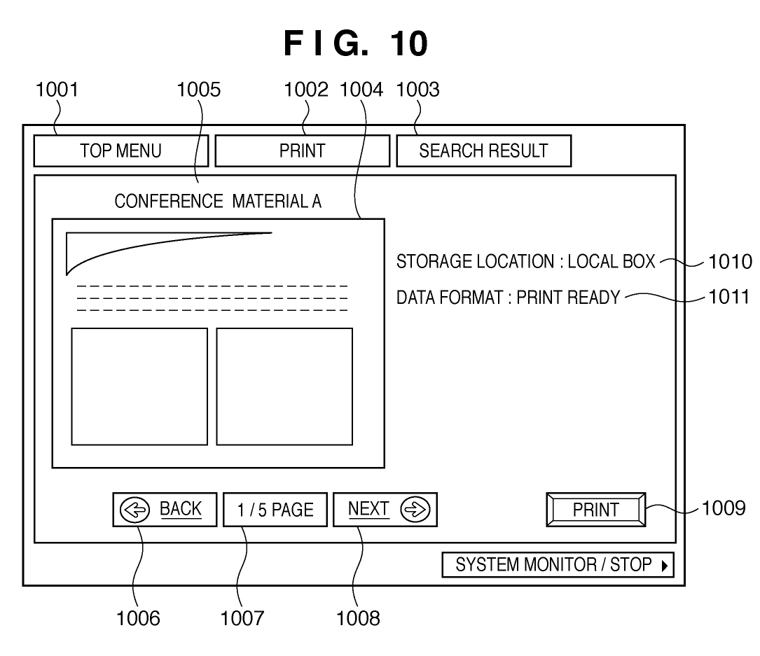

FIG. 10 is a view showing an example of the window that displays the detailed information of a document. The window shown in FIG. 10 is displayed when the user presses the tab 906 shown in FIG. 9. A tab 1001 is used to return to the initial window shown in FIG. 7. A tab 1002 is used to change to the print sub menu window shown in FIG. 8. A tab 1003 is used to return to the search result window shown in FIG. 9. A display 1004 indicates a document preview window. A display 1005 indicates a document name such as “conference material A”. Tabs 1006 and 1008 are used to change the page of the document. When the user presses these tabs, the document preview changes the page. A display 1007 indicates that the document has five pages, and page 1 is currently displayed. A tab 1009 is used to print the displayed document. A display 1010 indicates the document storage location such as “local box”. A display 1011 indicates the data format. As already described, one of “print ready data” and “connect ready data” is shown as the data format.

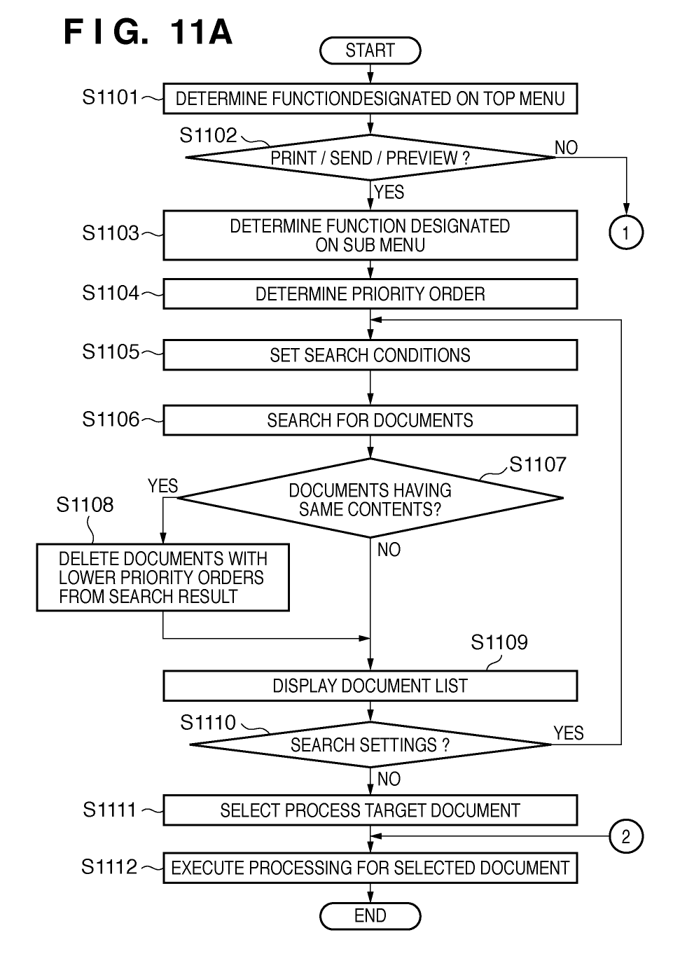

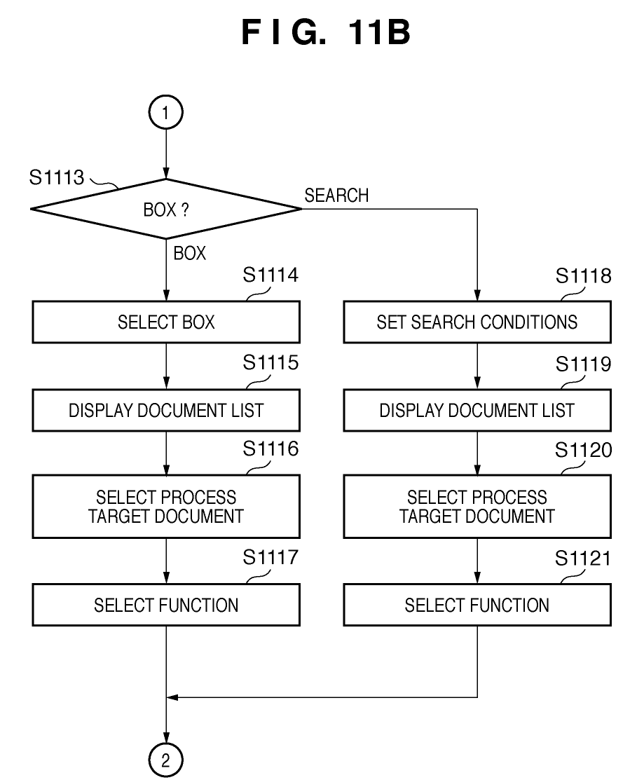

FIGS. 11A and 11B are flowcharts illustrating a procedure of data processing in the image processing system according to the embodiment of the present invention. The flowchart in FIGS. 11A and 11B show the procedure of data processing of performing the operation of a function desired by the user, displaying the document search result, and executing selected processing.

In step S1101, the desired function tab designated by the user in the top menu (initial window) shown in FIG. 7 is determined. When the user presses a function tab, the window changes to the window corresponding to the function. When one of printing, sending, and preview is selected in step S1102, the process advances to step S1103. In step S1103, a sub menu window corresponding to one of printing, sending, and preview is displayed, and which function is selected by the user in the sub menu window is determined. For example, when the user wants to print, he/she presses the tab 702 to change to the print sub menu window shown in FIG. 8. Then, the function selected by the user is determined.

In step S1104, the priority order of each document is determined based on the function selected by the user and the table showing the priority order in FIGS. 3A and 3B. For example, when the user selects the tab 803 in FIG. 8, a search is performed for all storage locations, and then, printing is executed. Hence, information of priority orders assigned to “printing of data in local box”, “printing of data in remote box”, and “printing of data in external memory” is acquired by referring to FIGS. 3A and 3B.

In this embodiment, the priority orders are determined based on the tables in FIGS. 3A and 3B. However, the present invention is not limited to this. For example, the priority order may be determined by calculating the assumed processing time based on the path every time. In this case, the transfer rate via the network at that time can be taken into consideration. It is therefore possible to more accurately determine the priority order.

In step S1105, the search condition setting window (FIG. 5) is displayed to cause the user to input search conditions. When the user presses the “search execution” button in the search condition setting window, the process advances to step S1106 to execute document search.

In step S1106, a document search is executed based on the function selected by the user in step S1103 and the search conditions set in step S1105. The search target storage location (e.g., local box, remote box, and external memory) is determined based on the selected function. In step S1106, a general search operation is performed to search for documents that satisfy the search conditions input by the user. The search result may temporarily be stored in a memory or the like. In this embodiment, each of the found documents is associated with a processing item of the document priority order table. For example, after the storage location and data format of a found document are identified, the document information may be added a priority order and path information and then stored in a memory.

In step S1107, it is determined whether documents having the same contents (to also be referred to as identical documents hereinafter) exist among the found documents. If it is determined that identical documents exist, the process advances to step S1108 to delete documents with lower priority orders from the search result while leaving a document having a highest priority order among the documents with the same contents. Then, the process advances to step S1109. On the other hand, if it is determined that no identical documents exist, the process advances to step S1109.

Assume that when the user selects the tab 803 in FIG. 8, and a search is performed for all storage locations, documents having the same contents are found. For example, if the documents which satisfy the search conditions and have the same contents are print ready data in the local box, connect ready data in the local box, and print ready data in the remote box, the data except for the print ready data in the local box are deleted from the search result.

Whether documents have the same contents is determined based on a document ID which is added to documents having the same contents in advance when storing them. However, the present invention is not limited to this. The determination may be done based on, for example, the document name, the save date, or the name of the user who has saved the document.

In step S1109, the display unit displays the list of documents of the search result.

As described above, when documents having the same contents are found by a document search, only a document having a highest priority order is displayed. This prevents a plurality of documents having the same contents from being displayed and also allows displaying a document that can be output fastest. It is therefore possible to prevent the user from selecting an inappropriate document with a low processing speed.

In step S1110, it is determined whether the tab 909 (narrow search) in FIG. 9 is selected. If it is determined that the tab is selected, the process returns to step S1105 to set search conditions. On the other hand, if the 909 tab is not selected, the process advances to step S1111 to cause the user to select a desired document from the displayed document list. In step S1112, the processing of the function selected in step S1103 is executed for the document selected in step S1111.

If it is determined in step S1101 that the box function (tab 705 in FIG. 7) is selected, the process advances to step S1114 via steps S1102 and S1113. In step S1114, the user is caused to select a desired storage location (local box, remote box, or external memory). In step S1115, the list of all documents stored in the box selected in step S1114 is displayed. In step S1116, the user is caused to select a desired document from the displayed document list. In step S1117, the user is caused to select a function (e.g., printing, sending, or preview) to be executed for the document selected in step S1116. The process advances to step S1112 to execute the processing of the selected function for the selected document.

If it is determined in step S1101 that the search function (tab 706 in FIG. 7) is selected, the process advances to step S1118 via steps S1102 and S1113. In step S1118, the user is caused to set search conditions, and a search is performed using the set search conditions. In step S1119, the list of documents found in step S1118 is displayed. In step S1120, the user is caused to select a desired document from the displayed document list. In step S1121, the user is caused to select a function (e.g., printing, sending, or preview) to be executed for the document selected in step S1120. The process advances to step S1112 to execute the processing of the selected function for the selected document.

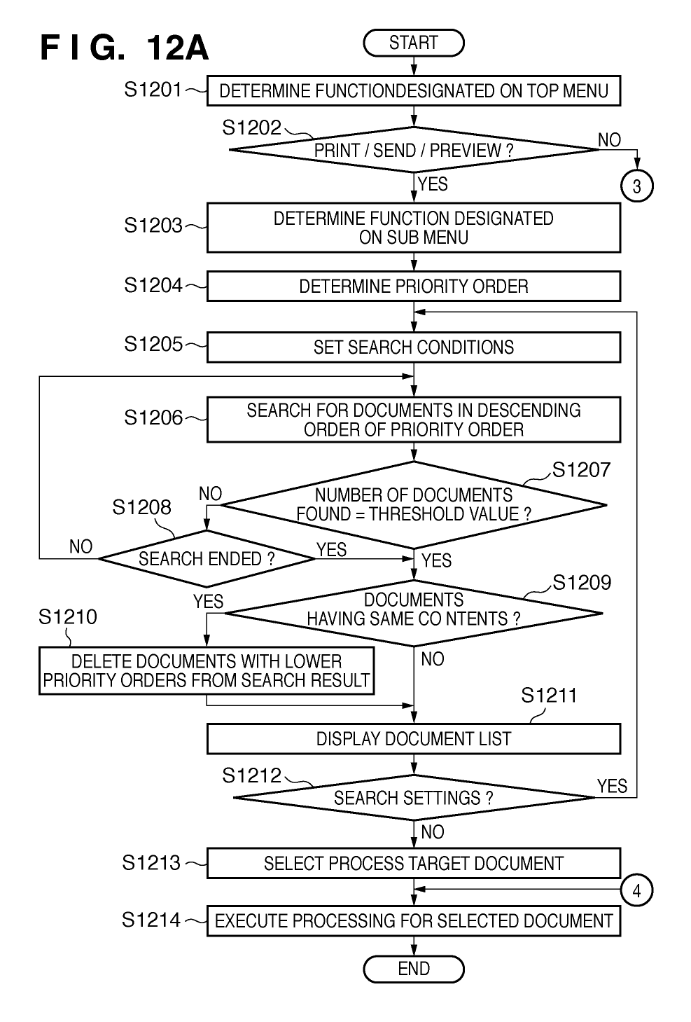

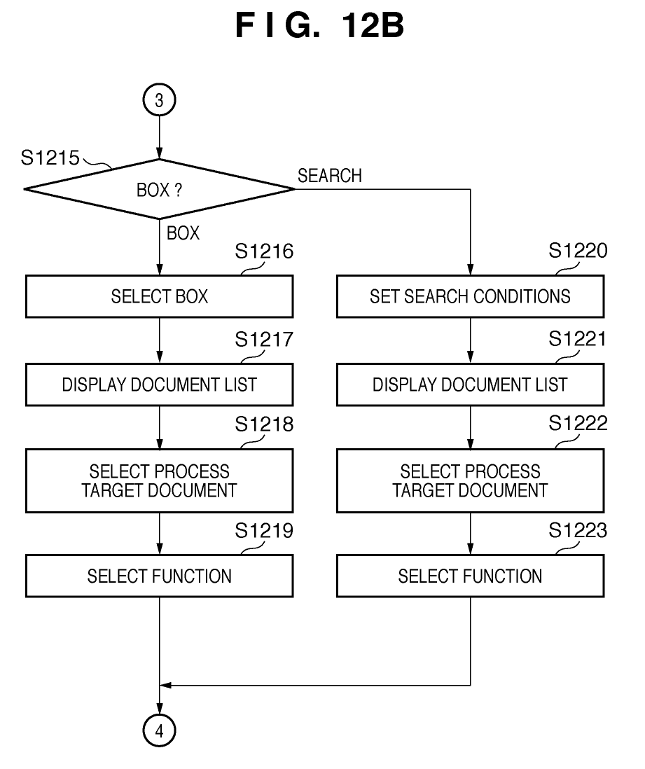

FIGS. 12A and 12B are flowcharts illustrating another procedure of data processing in the image processing system according to the present invention. In the procedure shown in FIGS. 12A and 12B, a process of stopping a search in progress when an enormous number of documents are found by the search is added to the flowcharts in FIGS. 11A and 11B.

Steps S1201 to S1205 in FIGS. 12A and 12B are the same as steps S1101 to S1105 in FIGS. 11A and 11B.

In step S1206, a document search is executed based on the priority orders. More specifically, in step S1206, a search is executed in descending order of priority. For example, when the user selects the tab 803 in FIG. 8, the search range includes all storage locations. The priority order of the print function is determined by referring to FIGS. 3A and 3B. In step S1206, first, a document search is performed for print ready data in the local box. When the search is ended, a document search is performed for connect ready data in the local box.

In step S1207, every time it is determined whether a document satisfies the search conditions, the number of documents that satisfy the search conditions is compared with a threshold value stored in a memory or the like in advance. If it is determined in step S1207 that the number of found documents has not reached the threshold value, the process advances to step S1208 to determine whether the search determination processing of all documents is ended. For example, if the search of all storage locations is ended in accordance with the priority order, the process advances to step S1209. On the other hand, if it is determined that the search is not yet ended, steps S1206 and S1207 are repeated. If it is determined in step S1207 that the number of documents that satisfy the search conditions has reached the threshold value, the document search is stopped, and the process advances to step S1209.

Steps S1209 to S1223 are the same as steps S1107 to S1121, and a detailed description thereof will not be repeated. In steps S1209 and S1210, if documents having the same contents are found from different storage locations or in different data formats, documents with lower priority orders are deleted. For this reason, only a document suitable for execution of the function selected by the user is displayed as the search result.

In the embodiment shown in FIGS. 12A and 12B, a document search is started from a document data format and storage location with a higher priority order by referring to the document priority order table. Hence, even when an enormous number of documents are found, and the search is stopped in progress based on the threshold value, documents with higher priority orders remain among the already found documents. In addition, documents having the same contents are deleted, and the user selects a document. That is, when documents having the same contents are found by a document search, only a document having a highest priority order is displayed. This prevents a plurality of documents having the same contents from being displayed and also allows displaying a document that can be output fastest. Additionally, since the search processing is stopped when the number of found documents has reached the threshold value, the search result is quickly displayed.

The present invention also incorporates a case in which the functions of the above-described embodiments are implemented when the operating system (OS) running on the computer partially or wholly executes actual processing based on the instructions of program codes (computer program). The present invention is also applicable to a case in which the program codes read out from a storage medium are written in the memory of a function expansion card inserted into the computer or a function expansion unit connected to the computer. In this case, the CPU of the function expansion card or function expansion unit partially or wholly executes actual processing based on the instructions of the written program codes, thereby implementing the functions of the above-described embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-246092, filed Sep. 21, 2007, and No. 2008-213227, filed Aug. 21, 2008, which is hereby incorporated by reference herein in their entirety.

What is claimed is:

1. An image forming apparatus comprising:
a function selection unit configured to cause a user to select a function to be executed by the image forming apparatus;
a determination unit configured to determine a priority order of a document based on the selected function, a storage location of the document, and attribute information of the document;
a search unit configured to search for a document based on the selected function; and
a display unit configured to display a list of documents selected from documents found by said search unit based on the priority order determined by said determination unit,
wherein when said search unit has found documents having the same contents, said display unit displays a document having a highest priority order in the list.

2. The apparatus according to claim 1, further comprising a memory unit configured to store a table in which the function, the storage location of the document, the attribute information of the document, and information of the priority order are associated with each other,
wherein said determination unit determines the priority order of the document based on the table and the selected function.

3. The apparatus according to claim 1, wherein the priority order is determined based on the selected function, the storage location of the document, and the attribute information of the document.

4. The apparatus according to claim 1, wherein the attribute information of the document represents a format of the document which corresponds to one of data after print image processing is executed and data suitable for sending before print image processing is executed.

5. The apparatus according to claim 1, further comprising:
a document selection unit configured to cause the user to select a desired document from the list displayed by said display unit; and
an execution unit configured to execute processing of the function selected by said function selection unit for the document selected by said document selection unit.

6. The apparatus according to claim 1, wherein when the function selected by said function selection unit is print processing, and a search target includes documents stored in a storage unit of a remote image forming apparatus, the priority order is determined depending on whether a model of the image forming apparatus is identical to a model of the remote image forming apparatus.

7. The apparatus according to claim 2, wherein the table includes information of a path to process the document.

8. The apparatus according to claim 1, wherein said search unit performs a search in descending order of priority order of documents, stops the search when the number of documents found has reached a threshold value, and presents the found documents as a search result.

9. An image forming method comprising:
a function selection step of causing a user to select a function to be executed by an image forming apparatus;
a determination step of determining a priority order of a document based on the selected function, a storage location of the document, and attribute information of the document;
a search step of searching for a document based on the selected function; and
a display step of displaying a list of documents selected from a plurality of documents found in the search step based on the priority order determined in the determination step,
wherein when documents having the same contents have been found in the search step, a document having a highest priority order is displayed in the list in the display step.

10. A computer program stored in a computer-readable storage medium, the program causing an image forming apparatus to execute:
a function selection step of causing a user to select a function to be executed by the image forming apparatus;
a determination step of determining a priority order of a document based on the selected function, a storage location of the document, and attribute information of the document;
a search step of searching for a document based on the selected function; and
a display step of displaying a list of documents selected from a plurality of documents found in the search step based on the priority order determined in the determination step,
wherein when documents having the same contents have been found in the search step, a document having a highest priority order is displayed in the list in the display step.
